(19) United States
(12) Patent Application Publication
(10) Pub. No.: US 2008/0010223 A1
(43) Pub. Date: Jan. 10, 2008

(54) Shipping Charge Calculation System and Method

(75) Inventors: Lance Hoffman, Bonsall, CA (US); Ahmad Ludin, Temecula, CA (US); Peter Joseph Bellomo, Scottsdale, AZ (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 11/767,245

(22) Filed: Jun. 22, 2007

Related U.S. Application Data
(60) Provisional application No. 60/815,900, filed on Jun. 22, 2006.

(51) Int. Cl. G06F 17/00

(52) U.S. Cl. 705/402

(57) ABSTRACT

A software module is implemented on a web site to calculate shipping rates based on different formulas and equations which will be beneficial to an operator of an e-commerce web site by increasing gross profit from shipping charges. This shipping charge calculation method may be implemented on select e-commerce store fronts to improve profits without negatively affecting sales. Shipping costs would be calculated on a combination of several factors. For instance, the shipping costs may be based on a weight, order value, and price. This increases revenue for a business because customers are more likely to pay higher shipping costs for relatively expensive items. An interface is provided in an e-commerce system manager with load weight tables, premium tables, base fees, and order values. These tables may also be imported and each store has the ability to use its own costs or use amounts from a global template.

### RELATED APPLICATIONS

This application claims the benefit of U.S. Provisional Application No. 60/815,900 filed 22 Jun. 2006, entitled “Shipping Charge Calculations,” which is incorporated herein by reference.

### FIELD OF THE INVENTION

The present invention relates to commerce systems for use on the Internet. More particularly, the present invention relates to a system and method for calculating shipping charges for goods while processing an order in an electronic commerce system.

### BACKGROUND OF THE INVENTION

Through the use of a common software structure, a network of computers known as the world-wide web or Internet enables vast and immediate interconnectedness for many users. This common software structure is known as hypertext markup language or “HTML” that is generated and read via browser computer software code. Access to information and movement around the Internet is enhanced through the use of hyperlinks (“links”) within a web page's HTML. The link, which is typically a word in a text field or an image on a web page, acts as a path that moves a user from one web page address, Uniform Resource Locator (URL), to another web page address on a web site. The movement from one URL to another allows near-instant access to information, products, and services and is particularly well-suited to the exchange of information, goods, and services between buyers and sellers. Such business is commonly referred to as “e-commerce,” or “electronic commerce.”

On-line commerce is now an important part of our economy, mainly because of the efficiency and the ready convenience that e-commerce provides.

Furthermore, online merchants have discovered the value of selling their goods via the Internet. For example, many e-commerce systems allow buyers to place goods in a virtual “shopping cart”, and then when the buyer is prepared to finalize the purchase, they proceed to the “checkout.” At this stage, all of the items in the buyer's shopping cart are displayed with their prices, tax, shipping and handling, and a total amount due is shown to the buyer. The buyer can then enter credit card information, and pressing a “submit” button sends the credit card information to the merchant, who then authenticates the credit card and receives an authorization for the sale. Because of the unique characteristics of the Internet, carrying out commercial transactions over the Internet presents new issues and new opportunities.

With the abundance of goods and services available, a problem arises in calculating optimal shipping charges while processing orders for those goods and services on a commerce system. Traditionally, a seller sets up a website with a series of pages organized as an electronic storefront. From the storefront, buyers are able to select products to purchase and initiate a purchase order transaction. However, a need exists for optimizing the amount charged for shipping based on a number of factors such as purchase amount, shipping weight, and delivery distance. The challenge of calculating shipping charges increase when a single product may be delivered from multiple sources and/or distribution centers.

Prior shipping calculation systems had many ways of calculating the shipping and handling fee for products on the storefronts. Different calculations for shipping fees are permitted in prior shipping calculation systems by updating a variable to choose a different method. In addition, prior shipping calculation systems do shipping rates calculations based on a flat rate fee or by calculating it from shipping tables.

The present invention provides a solution to these needs and other problems, and offers other advantages over the prior art.

### BRIEF SUMMARY OF THE INVENTION

The present invention is related to a software system that solves the above-mentioned problems. In accordance with one embodiment of the invention, a software module is implemented on a web site to calculate shipping rates based on different formulas and equations which will be beneficial to an operator of an e-commerce web site by increasing gross profit from shipping charges. This shipping charge calculation method may be implemented on select e-commerce store fronts to improve profits without negatively affecting sales.

Many online stores calculate shipping charges based on a weight of the item purchased. For example, a $10,000.00 computer may weigh 15 lbs. The cost of shipping for that computer may only be around $20.00, depending on the destination and postal zone. Conversely, a $250.00 sofa may weigh around 100 lbs, yet the cost of shipping may be $70.00. The customer who purchased the more expensive computer gets cheaper shipping, and the customer who purchased the heavier sofa gets shipping that is a third of its total cost. In a preferred embodiment of shipping charge calculation system and method, the shipping costs would be calculated on a combination of several factors instead of merely the weight of an item. For instance, the shipping costs may be based on a weight, order value, and price. This system and method increases revenue for a business because customers are more likely to pay higher shipping costs for relatively expensive items. Furthermore, shipping charge system and method ultimately calculates the shipping charge based on both weight and an invoice amount. After calculating the shipping charge based on both weight and invoice amount, the calculation is added to a base fee, and then any premium fees are added further to result in a final shipping charge.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 illustrates an overview diagram for shipping charge calculation system and method.

FIG. 2 shows a flow chart for one embodiment of shipping charge calculation system and method.

FIG. 3 shows an initial user interface page.

FIG. 4 illustrates a weight table user interface page.

FIG. 5 illustrates another weight table user interface page.

FIG. 6 shows a user interface page for shipping cost and methods.

FIG. 7 illustrates an import shipping calculation interface page.

### DETAILED DESCRIPTION

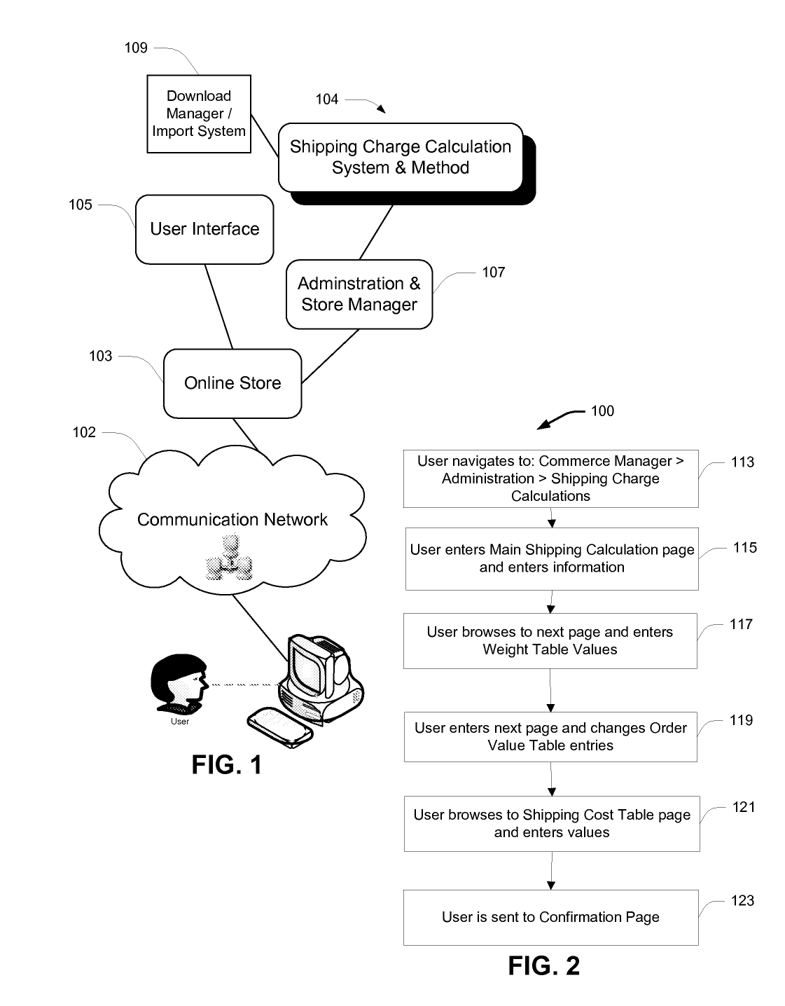

As shown in FIG. 1, a shipping charge calculation system and method 104 operates over a communication network 102. In a preferred embodiment of shipping charge calculation system and method, a user may load shipping rates for individual orders that increase gross profit for an e-commerce web site operator and also make it more tempting for customers to choose a higher method of shipment to receive the product quicker. Preferably, four optional methods of shipment are provided. Ground shipping fees can be calculated and then the other three methods will build off the previous method of shipment. Thus, there are four formulas that the system will need to run to get shipping rates for a particular order. Again referring to FIG. 1, the user browses to an online store 103. The online store 103 may have a user interface 105 and also an administration & store manager 107 that manages the non catalog portion of the online store 103. The administration & store manager 107 could also be an e-commerce system manager. In a preferred embodiment, shipping charge calculation system and method 104 is part of the administration & store manager 107. Furthermore, a download manager and import system 109 allows the user to import the shipping charges and other variables into a matrix for future ease of updating values and costs.

In addition, the e-commerce system manager 107 has load weight tables (fees and costs), premium tables, base fees, and order values (sub-total). These tables may also be imported, and each store has the ability to use its own costs or use amounts from a global template. A shipping zone can be changed if required, but as a default value, “Zone 5” (i.e., the furthest distance) is used for all shipping rate lookups. The interface 105 allows users to easily configure parameters in a shipping charge calculation formula.

For purposes of this description, electronic software download (ESD) products will be assumed to have no shipping and as such will not be included in the order value (sub-total) lookup table. If two products are in the basket and one item is an ESD item, only the physical item that will be shipped should be use for the lookup.

### Formulas

There are four formulas, or algorithms, to calculate new shipping rates. Each shipping method will have its own formula but will use the result from the previous shipping method, except for Ground Shipping. There are six tables and four lookup fields that generate all the calculations. The calculations are as follows, with abbreviations defined in Table 1.

G=BF+OV(lookup)+WT(lookup)+PREMIUMg

2day=G+Delta(2dayCOST−gCOST)+PREMIUM2day

1day=2day+Delta(1dayCOST−2dayCOST)+PREMIUM1day

P=1day+Delta(pCOST−1dayCOST)+PREMIUMp

TABLE 1
Abbreviations

OV: Order Value (sub-total of products, tax and shipping not included)
WT: Weight
BF: Base Fee
G or g: Ground Shipping
2 day: 2 day shipping service, Second Day
1 day: Next day afternoon shipping service
P or p: priority next day shipping before 10 a.m.

### Value Lookups

The following value lookups should be editable and viewable by certain people based on what permission they have.

### Base Fee—(BF)

A base fee (BF) table contains a flat or base fee that is charged for calculating the ground shipping rate. For example, BF=$4.50 or $0.

### Over Value Table—OV(lookup)

An order value (OV) lookup table has pre-determined values ranging from $0 to $5,001. This should be the sub-total of all products and quantities. It does not include tax or shipping cost. This table has incremented values for the fees in which the fees increment by different values. An excel spreadsheet file is attached which contains the data.

### Weight Lookup Table—WT(lookup)

This is another table which lists weight values from 0 to 150 pounds. Each pound has a different value attached to it. The values increment by different amounts after different weight amounts.

### Ground Shipping Cost Table—(gCOST)

This table contains the cost for ground shipping. This is based on weight and the default Zone 5. It will be understood that Zone refers to a United States Postal code.

### 2 Day Shipping Cost Table—(2dayCOST)

This table contains cost for Second Day shipping. This is based on weight and the default Zone 5.

### 1 Day Shipping Cost Table—(1dayCOST)

This table contains cost for Next Day afternoon shipping. This is based on weight and the default Zone 5.

### Premium Shipping Cost Table—(pCOST)

This table contains cost for Premium shipping (Next Day Morning). This is based on weight and the default Zone 5.

### Premium for Ground Shipping—(PREMIUMg)

This is a premium added to ground shipping. This premium may be set to 0, for example PREMIUMg=$0, or $4.50.

### Premium for 2 Day Shipping—(PREMIUM2day)

This is a premium that is added to 2 Day (Second Day) Shipping methods. For example, PREMIUM2 day=$1.

### Premium for 1 Day Shipping—(PREMIUM1day)

This is a premium that is added to 1 Day (Next Day Afternoon) Shipping methods. For example, PREMIUM1day=$1.

### Premium for Priority Shipping—(PREMIUMp)

This is a premium that is added to Priority (Next Day Morning) Shipping methods. For example, PREMIUMp=$1.

Before calculating the 2 Day Shipping fee, the ground shipping fee will need to be calculated. To calculate the 1 Day Shipping fee, the 2 Day Shipping fee must be calculated first and so on. Thus, each formula is dependent upon another.

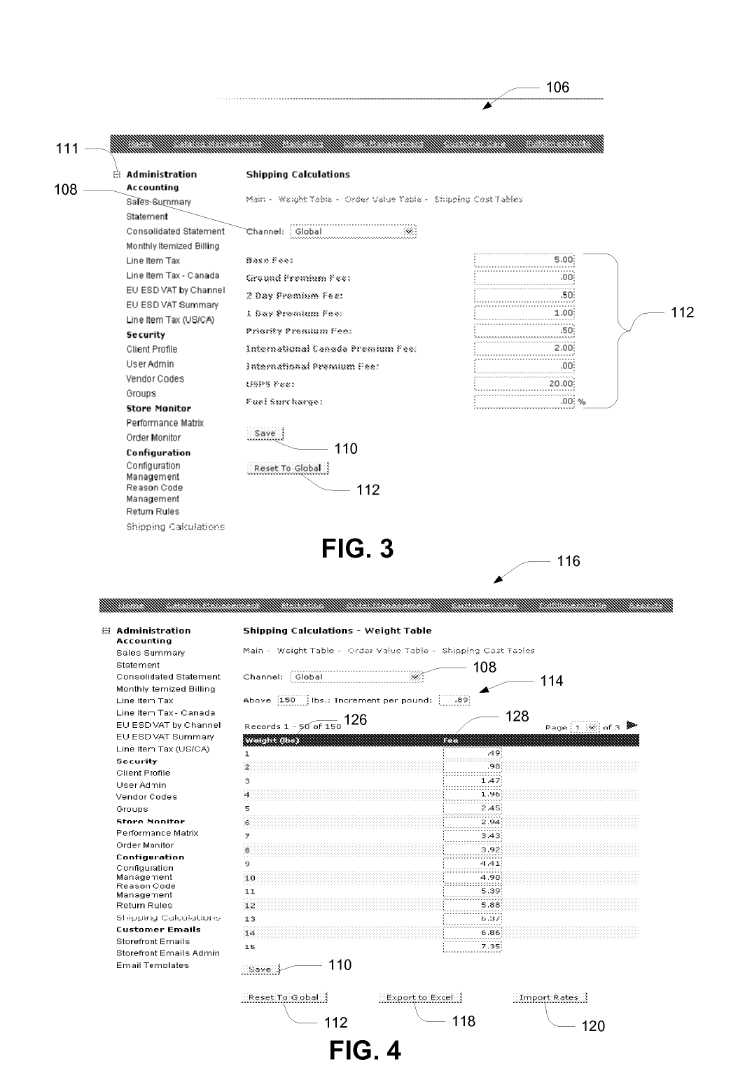

The e-commerce system manager 107 has a section where shipping information can be updated. In one preferred embodiment a link is added under an “Administration” tab 111, under a Configuration heading, and is called “Shipping Calculations”, as shown in FIG. 3.

To reiterate, the lookup expression is a fee in a database for a particular item, for example: OV(lookup) means that one needs to lookup the order value in the database, then that value is used in the equation. For example, if the order value is $100, the system would lookup $100 in the table and grab whatever the value is that should be added to shipping. That value would be the OV(lookup) value that would be placed in the equation. The same goes for the WT lookup, which is the weight lookup value in the database. It will be understood by one of ordinary skill in the art that a database may also be a table, matrix, or grid. It will also be understood that a base fee may also be called a flat fee.

Furthermore, the COST is the shipping cost that one is charged. So the gCOST would be the amount charged from the shipper to ship an item of a specific weight using the ground shipping method. For example, if FedEx charges $4.50 to ship a one pound product using ground shipping, the $4.50 would be the gCOST. The same goes for the 2dayCOST, 1dayCOST, etc. Those are the actual shipping costs that one is charged by the carrier. It will be understood by one of ordinary skill in the art that delta means subtraction.

The expression PREMIUM is premium amount, if any, that is added to the ground, 2day, 1day, etc. Hence, PREMIUMg is a specific premium amount that is added to ground shipping. This could be zero or it could be a small amount that is added to all ground shipping charged to the customer.

Moreover, if a customer chooses ground shipping, the minimum values needed are the weight amount and the order value of their order. The system can then calculate how much to charge ground shipping. If other methods are needed, then the shipping costs for that method plus the prior method are necessary. Basically, the equations build upon each other. For example, for 1 day shipping, the user needs to know the shipping cost of 1 day and 2 day. The shipping costs, order value lookups, and weight lookups are all saved in a database. From the customer order, the user needs the total weight and total order value so that they can look those up in the database and calculate the shipping to charge the customer. Thus, the formula:

G=OV(lookup)+WT(lookup)

is a “bare bones” equation of an embodiment of shipping charge calculation system and method, utilizing both the order value and weight to generate a final shipping charge. The flat, or base fee and the premium charges may be further added to this formula to make the preferred embodiment of shipping charge calculation system and method, resulting in the equation:

G=BF+OV(lookup)+WT(lookup)+PREMIUMg

which then may be used to generate various types of shipping charges that other equations build upon, described supra.

FIG. 2 shows a flow chart 100 for one preferred embodiment of shipping charge calculation system and method. For example, the user would first 113 navigate through the online store to a commerce manager, then administration, then to shipping charge calculation system and method. Here the user would enter 115 the main shipping calculation page (shown supra) and inputs pertinent information for the calculations. Next, the user browses 117 to a page to enter weight table values, and then the user enters 119 the next page to change order value table entries. After that, the user browses 121 to a shipping cost table and enters those particular values. Finally, the user is sent 123 to a confirmation page that checks and verifies the information entered in the previous pages. It will be understood by one of ordinary skill in the art that these steps may be combined and not all steps are necessary to perform the ultimate function of calculating the shipping charge based on both weight and an invoice amount. After calculating the shipping charge based on both weight and invoice amount, the calculation is added to a base fee, and then any premium fees are added further to result in a final shipping charge.

### Main Page

Referring now to FIG. 3, a shipping calculations page 106 shows the “Global” dropdown 108 as selected and has the boxes 112, also displayed in Table 2. It will be understood by one of ordinary skill in the art that a dropdown is a menu whose title is normally visible but whose contents are shown only when the user activates it, normally by clicking on the title or a small arrow next to the title, whereupon the menu items appear below the title. The user may select an item from the menu by dragging the mouse from the menu title to the item and releasing, or by clicking the title and then clicking the item.

Most stores use a global setting. Thus if the user makes changes to an individual store, it should save the changes for that store without touching the global rate.

TABLE 2
Global Dropdown

1) Base Fee
2) Ground Premium Fee
3) 2 Day Premium Fee
4) 1 Day Premium Fee
5) Priority Premium Fee

Furthermore, users that have permission to view the page will be able to see the page without a “Save” 110 button. If the user has permission to change the fees, then they will see a “Save” 110 button. Another button is visible that says “Reset to Global” 112 and this should reset the values to the global value if another channel is selected. Additionally, the user may edit the boxes 112 with the preferable fee. This page 106 also has links to the other sections where the user can update the fees and costs for shipping.

### Weight Table

Referring to FIG. 4, a weight table page 116 is shown. Shipping weights, for example, may be listed from zero to 150 lbs. Moreover, an increment option 114 allows the user to add a fee increment for weights greater than 150 lbs. The increment adds the amount to each pound after 150. It uses the fee for 150 lbs and adds the incremental fee for each extra pound.

This page has the “Global” dropdown 108 for the channel. The user can change the numbers to the global numbers by clicking on the “Reset to Global” button 112 towards the bottom of the page. Only users with permission are able to edit this page. Thus, if the user only has view rights, they will not see the “Save” 110 or “Reset to Global” 112 button.

Next to that button there is an “Export to Excel” button 118 which exports the two fields. There is also an “Import Rates” button 120 that allows the user to upload a new rate file. This import file is in the same format as the file that is exported. Thus, the user can export the file to an excel spreadsheet, make edits, and then import it back without any problems. This process requires two fields: 1) Weight (from one to 150 lbs) and 2) Rate.

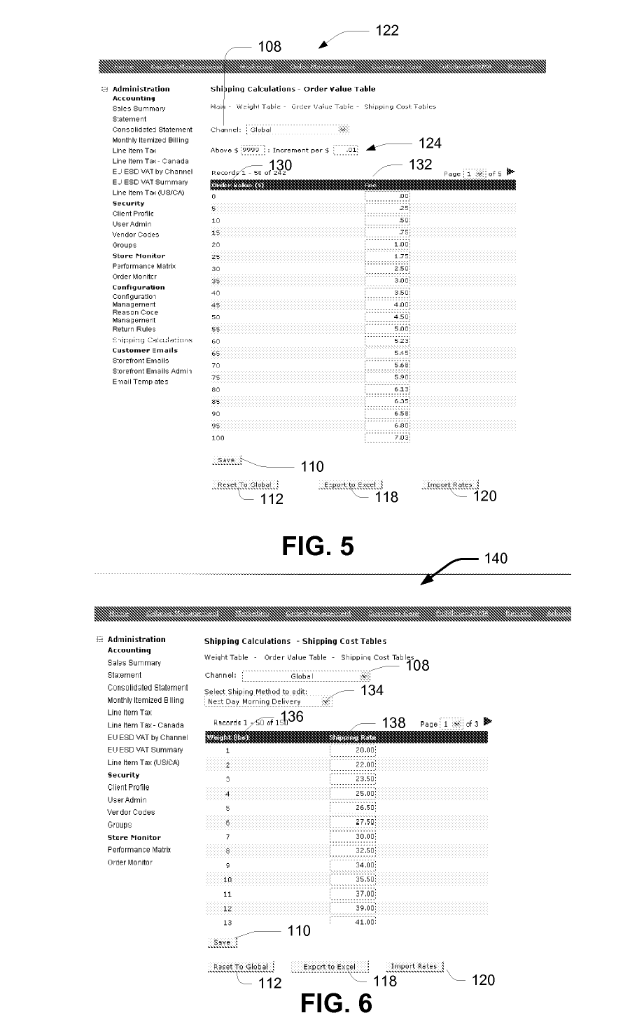

The import makes certain that there are only two columns, weight 126 and fee 128, are imported and any errors are shown to the user. The import and export work for the channel selected. If a different channel is selected, then it imports for that channel. FIG. 5, explained infra, further elaborates on importing shipping calculations.

### Order Value Table

Referring now to FIG. 5, an order value table page 122 is illustrated. In a preferred embodiment of shipping charge calculation system and method, the page is similar to the weight table page shown in FIG. 4, but it will contain an order value from 0 to 5001. An order value 130 is the sub-total of the products, and does not include the shipping or tax. Fee 132 is calculated into the formulas listed supra. This order value table page 122 contains the same features as the weight table page 116, such as channel 108, “Save” 110, “Reset to Global” 112, “Export to Excel” 118, and “Import Rates” 120.

The increment option 124 specifies that order value settings on the page only go up to $9999. This box adds an amount to dollar amounts over that amount. For example, the user purchases a product that is $10,001. That is two dollars over the last amount listed. This will tell the system to add a penny (0.01) for each dollar amount that is over $9999. If the amount is $67.03, and the increment is 0.01 for each one, for $10,001 it will add 0.02 pennies to $67.03, making the value for $10,001 be $67.05.

### Shipping Cost Fees and Zone

In another preferred embodiment of shipping charge calculation system and method, different shipping methods may be edited. Referring to FIG. 6, a page for shipping cost tables 140 is described. This is another table that can be edited by certain users that have permissions. Preferably, “Zone 5” is set as the default zone for all shipping methods. It will be understood by one of ordinary skill in the art that the zone is a standard zone set by a postal service for shipping items depending on the distance of a shipping destination. Therefore, the shipping cost is retrieved from the cost table for “Zone 5”. Thus, to utilize the costs for a different zone (i.e., Zone 1 or 2), the user would need to update the shipping cost table page 140 to have those particular different zone rates. The user may choose a method from a shipping method dropdown 134. Weights 136 and shipping rate 138 columns may also be edited.

This page also has the “Export to Excel” 118 and “Import Rates” 120 functionality where the user can import shipping costs for each individual shipping method or export them to spreadsheets. Only clients that need to change shipping costs may access this page. Therefore clients who handle their own shipping can use this page.

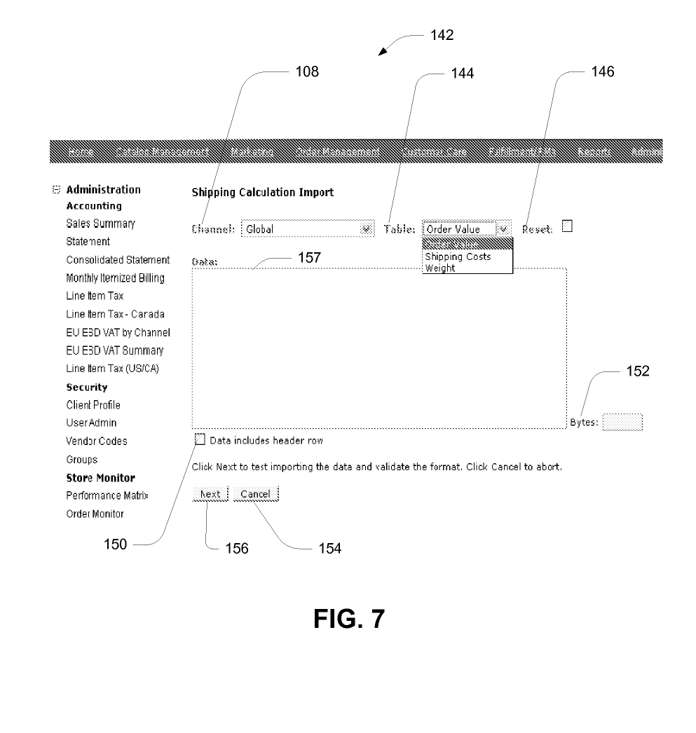

As shown in FIG. 7, a shipping calculation import page 142 allows the user to do a bulk import for the weight values, order values and shipping costs. This functionality allows the user to update all of the values at once instead of changing one value at a time on the actual settings page. As with previous figures, here the channel 108 is chosen from the dropdown. The user also chooses a table type 144 from the dropdown menu. This can be order value, shipping costs, or weight (as shown in FIG. 7). By checking a reset 146 box the user can reset the values entered, and by checking a data includes header row box 150 the user can include information from the header row. A bytes 152 section shows how many characters have been entered into a data box 157. The data box 157 stores comma separated values. Clicking “Next” 156 will lead the user to a test import data page and validating format (not shown). For example, the message on the next page may confirm there are no errors, such as “Successfully imported 64 lines. No errors occurred.” Conversely, clicking “Cancel” 154 aborts the importing process.

### Logging

In another embodiment of shipping charge calculation system and method, the system logs the shipping fees and values. This page (not shown) may contain a “field name edited”, “username”, “date & time edited”, “channel (store name)”, “old value”, and “new value”. This log page tracks the base fee, ground premium fee, 2 day premium fee, 1 day premium fee, and priority premium fee. The field name edited is first field shown on the report. This may say for example: “Ground Premium Fee.”

Individual changes to the shipping rate tables are also logged in this page. This page links on the top of the shipping pages and there is a separate link called “Shipping Change Log”. This only shows for internal system administrators. A new permission is setup for this option to view this link only for internal administrators. The page paginates and displays 100 lines on each page so that it does not get too large. There is also a date range that can be searched. The date range defaults to the current month.

### Permissions

In a preferred embodiment of the system, five permission settings are implemented for the above sections. These permission settings include the following shown in Table 3.

TABLE 3
Permission Settings

Edit Shipping Fees (ability to VIEW and EDIT shipping fees, premiums,
base fee, weight fee, order value fee, Zone change).
View Shipping Fees (ability to ONLY VIEW shipping fees, premiums,
base fee, weight fee, order value fee). NO editing allowed.
View Shipping Costs table (ability to ONLY VIEW shipping costs for
different shipping methods).
Edit Shipping Costs table (ability to VIEW and CHANGE shipping costs
for different shipping methods).
View Shipping Log (ability to VIEW the shipping log. Internal only)

It will be understood by one of ordinary skill in the art that there will be multiple scenarios in which users may interface with the system. Table 4 outlines a few example use cases.

TABLE 4
Operational Scenarios and Use Cases

View & Edit Costs: An administrator has the ability to view and edit
shipping costs. A permission also needs to be set for this as mentioned
above in Table 3. This will most likely be used by an Operations Manager
or a client that handles own shipping.
View Log Page: An internal administrator is able to view a log page which
shows who and what changes were made recently to any of the values
and premiums in this new shipping functionality.
Add Shipping Override: An administrator has the ability to add a shipping
override for a particular SKU. Thus when there is a chance to add a
premium to a specific popular product, a user can add it easily without
having to update the whole rate table.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention. In addition, the ranges of the variables described above are meant to be examples only. It will be appreciated by those skilled in the art that the actual values of these variables may be changed to reflect the business rules for shipping charge calculation best suited to a particular customer without departing from the scope and spirit of the present invention as described above.

What is claimed is:

1. A software module for shipping charge calculation in an electronic commerce system, the software module being operatively configured to calculate a preliminary shipping charge for a purchase order based on weight of a product in the order and a value of the order and to add a base fee to the preliminary shipping charge to generate a final shipping charge.

2. The software module of claim 1 wherein the software module is operatively configured to utilize an algorithm to generate the final shipping charge.

3. The software module of claim 2 wherein the algorithm is described by an equation as follows:
G=OV(lookup)+WT(lookup)
such that the equation determines ground shipping (G) based on the order value (OV) and the product weight (WT) whereby expression OV(lookup) refers to a fee derived from a table based on OV and expression WT(lookup) refers to a fee derived from a table based on WT.

4. The software module of claim 3 wherein the equation further comprises a premium charge (PREMIUMg) resulting in the following equation:
G=OV(lookup)+WT(lookup)+PREMIUMg
whereby the equation is utilized to generate the final shipping charge.

5. The software module of claim 3 wherein the equation further comprises a base fee (BF) resulting in the following equation:
G=BF+OV(lookup)+WT(lookup)
whereby the equation is utilized to generate the final shipping charge.

6. The software module of claim 3 wherein the algorithm is further described by at least one equation as follows:
G=BF+OV(lookup)+WT(lookup)+PREMIUMg (equation 1);
2day=G+Delta(2dayCOST−gCOST)+PREMIUM2day (equation 2);
1day=2day+Delta(1dayCOST−2dayCOST)+PREMIUM1day (equation 3);
and
P=1day+Delta(pCOST−1dayCOST)+PREMIUMp (equation 4),
such that the G equation determines ground shipping based on a base fee (BF), OV(lookup), WT(lookup), and a premium charge (PREMIUMg); the 2day equation determines second day shipping based on G, a second day shipping cost (2dayCOST), a ground shipping charge (gCOST), and a premium charge (PREMIUM2 day); the 1day equation determines one day shipping based on 2day, a next day shipping cost (1dayCOST), 2dayCOST, and a premium charge (PREMIUM1day); and the P equation determines priority next day shipping based on 1day, 1dayCOST, a priority charge (pCOST), and a premium charge (PREMIUMp).

7. The software module of claim 2 wherein the algorithm calculates the final shipping charge with variables chosen from a group consisting of: value lookups, base fee, product weight, ground shipping cost, 2 day shipping cost, 1 day shipping cost, premium shipping cost, premium ground shipping, premium 2 day shipping, premium 1 day shipping, and premium priority shipping.

8. The software module of claim 1 wherein the software module is operatively configured to utilize a bulk import tool such that a user can update a table related to at least one of: the product weight, the order value, and a shipping cost.

9. The software module of claim 1 wherein the software module is operatively configured to utilize a graphic user interface (GUI) over a network whereby a user can edit settings.

10. The software module of claim 1 wherein the software module is operatively configured to function as a web service utilizing hypertext transfer protocol (HTTP) to convey information over a network.

11. A method for calculating shipping charges in an electronic commerce system, comprising steps of:
calculating a preliminary shipping charge for a purchase order based on weight of a product in the order and a value of the order; and
adding a base fee to the preliminary shipping charge to generate a final shipping charge.

12. The method of claim 11 wherein the calculating step further comprises utilizing an algorithm to generate the final shipping charge.

13. The method of claim 12 wherein the algorithm is described by an equation as follows:
G=OV(lookup)+WT(lookup)
such that the equation determines ground shipping (G) based on the order value (OV) and the product weight (WT) whereby expression OV(lookup) refers to a fee derived from a table based on OV and expression WT(lookup) refers to a fee derived from a table based on WT.

14. The method of claim 13 wherein the equation further comprises a premium charge (PREMIUMg) resulting in the following equation:
G=OV(lookup)+WT(lookup)+PREMIUMg
whereby the equation is utilized to generate the final shipping charge.

15. The method of claim 13 wherein the equation further comprises a base fee (BF) resulting in the following equation:
G=BF+OV(lookup)+WT(lookup)
whereby the equation is utilized to generate the final shipping charge.

16. The method of claim 13 wherein the algorithm is further described by at least one equation as follows:
G=BF+OV(lookup)+WT(lookup)+PREMIUMg (equation 1);
2day=G+Delta(2dayCOST−gCOST)+PREMIUM2day (equation 2);
1day=2day+Delta(1dayCOST−2dayCOST)+PREMIUM1day (equation 3);
and
P=1day+Delta(pCOST−1dayCOST)+PREMIUMp (equation 4)
such that the G equation determines ground shipping based on a base fee (BF), OV(lookup), WT(lookup), and a premium charge (PREMIUMg); the 2day equation determines second day shipping based on G, a second day shipping cost (2dayCOST), a ground shipping charge (gCOST), and a premium charge (PREMIUM2day); the 1day equation determines one day shipping based on 2day, next day shipping cost (1dayCOST), 2dayCOST, and a premium charge (PREMIUM1day); and the P equation determines priority next day shipping based on 1day, 1dayCOST, a priority charge (pCOST), and a premium charge (PREMIUMp).

17. The method of claim 11 wherein the algorithm calculates the final shipping charge with variables chosen from a group consisting of: value lookups, base fee, product weight, ground shipping cost, 2 day shipping cost, 1 day shipping cost, premium shipping cost, premium ground shipping, premium 2 day shipping, premium 1 day shipping, and premium priority shipping.

18. The method of claim 11 wherein the calculating step further comprises utilizing a bulk import tool such that a user can update a table related to at least one of: the product weight, the order value, and a shipping cost.

19. The method of claim 11 wherein the calculating step further comprises utilizing a graphic user interface (GUI) over a network whereby a user can edit settings.

20. The method of claim 11 further comprising a step of utilizing hypertext transfer protocol (HTTP) to convey information over a network such that shipping charges are calculated using a web service.
